(19) United States
(12) Patent Application Publication
(10) Pub. No.: US 2023/0382401 A1
(43) Pub. Date: Nov. 30, 2023

(54) INFORMATION PROCESSING APPARATUS, CONTROL METHOD, AND STORAGE MEDIUM, NOTIFYING INFORMATION TO A USER WHO IS RIDING OR IS OTHERWISE WITH A MOVING OBJECT

(71) Applicant: CANON KABUSHIKI KAISHA, Tokyo (JP)

(72) Inventor: RENTARO IMAI, Kanagawa (JP)

(21) Appl. No.: 18/320,090

(22) Filed: May 18, 2023

(30) Foreign Application Priority Data
May 26, 2022 (JP) 2022-086421

(51) Int. Cl. B60W 40/09

(52) U.S. Cl. CPC B60W 40/09; B60W 2300/36; B60W 2420/42; B60W 2554/4041

(57) ABSTRACT

An information processing apparatus is provided that executes instructions to acquire surrounding information or external information about a moving object, determine a riding state of a user with respect to the moving object based on the acquired information, determine, based on the user's riding state with respect to the moving object, information to be notified to the user from among the acquired information, and notify the determined information to the user.

### BACKGROUND

### Field

The present disclosure relates to an information processing apparatus notifying information to a user who is riding or is otherwise with a moving object.

### Description of the Related Art

In recent years, information processing apparatuses have been developed that attach to a moving object such as a bicycle and connect to a device such as a camera or a smartphone, and notify various pieces of information to a user.

Japanese Patent No. 5924395 discusses a system that notifies a user of whether another vehicle is operating dangerously and switches, based on the speed of a user's vehicle, between communicating such information via display notification and voice notification.

Meanwhile, in a state where the user is riding on a moving object, for example, the user may be concentrating on driving the moving object and thus may only be able to receive a limited amount of information. On the other hand, in a state where the user is walking with the moving object or a state where the user is on the moving object while the moving object is at rest, the user may have the ability to receive more information. Japanese Patent No. 5924395 does not mention the contents of the notification and the amount of information therein, and thus with that system it can be difficult to transmit the optimal contents and amount of information based on a user's riding state.

### SUMMARY

According to various embodiments of the present disclosure, an information processing apparatus is provided that executes instructions to acquire surrounding information or external information about a moving object, determine a riding state of a user with respect to the moving object based on the acquired information, determine, based on the user's riding state with respect to the moving object, information to be notified to the user from among the acquired information, and notify the determined information to the user.

Further features of the present disclosure will become apparent from the following description of example embodiments with reference to the attached drawings.

### BRIEF DESCRIPTION OF THE DRAWINGS

FIG. 1 is a block diagram illustrating a functional configuration according to a first example embodiment.

FIG. 2 is a diagram illustrating examples of a user's riding state with respect to a moving object.

FIG. 3 is a diagram illustrating a first state where the user is riding the moving object.

FIG. 4 is a diagram illustrating a second state where the user is walking the moving object.

FIG. 5 is a diagram illustrating a third state where the user is on the moving object at rest.

FIG. 6 is a diagram illustrating a fourth state where the moving object is stopped without the user being on the moving object.

FIG. 7 is a diagram illustrating examples of contents to be notified by an information processing apparatus.

FIG. 8 is a flowchart illustrating an operation according to the first example embodiment.

FIG. 9 is a diagram illustrating the contents to be notified in each riding state according to one embodiment.

FIG. 10 is a block diagram illustrating functional configurations according to a second example embodiment.

FIG. 11 is a flowchart illustrating operations according to the second example embodiment.

### DESCRIPTION OF THE EMBODIMENTS

A first example embodiment will be described below with reference to the accompanying drawings.

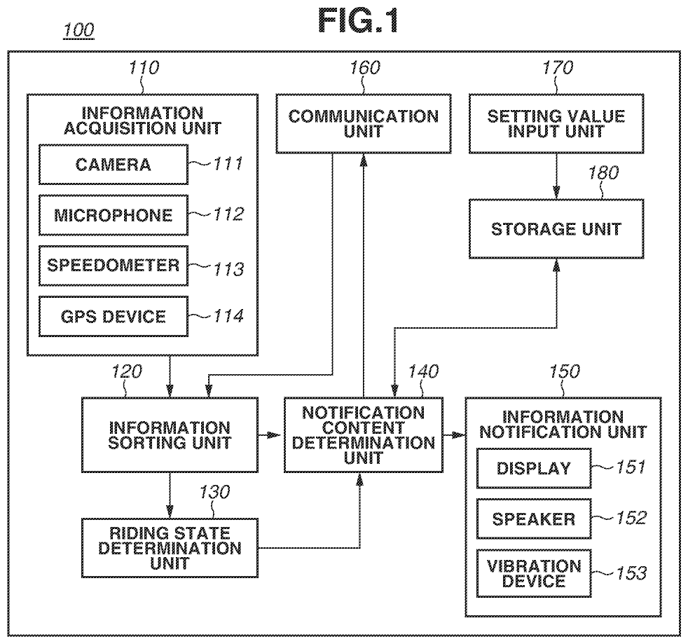

FIG. 1 is a block diagram illustrating an example configuration of an information processing apparatus 100 according to the present example embodiment. The information processing apparatus 100 is a device for notifying various pieces of useful information to a user who is riding a moving object such as a bicycle or a motorcycle. When attached to the moving object, the information processing apparatus 100 makes it possible to notify various kinds of information, including safety information for safe traveling and surrounding information such as nearby stores, to the user using the moving object.

As illustrated in FIG. 1, the information processing apparatus 100 includes an information acquisition unit 110, an information sorting unit 120, a riding state determination unit 130, a notification content determination unit 140, an information notification unit 150, a communication unit 160, a setting value input unit 170, and a storage unit 180.

The information acquisition unit 110 includes a group of units for acquiring various pieces of information. More specifically, the information acquisition unit 110 includes a camera 111 for capturing images of the front, sides, and back of the moving object, a microphone 112 for capturing environmental sounds and the user's voice, a speedometer 113 for measuring the moving speed of the moving object, and a Global Positioning System (GPS) device 114 for acquiring position information about the current location of the moving object. The various pieces of information acquired by the information acquisition unit 110 are output to the information sorting unit 120. The information acquisition unit 110 acquires image data and video data from the camera 111. The information acquisition unit 110 also acquires audio signals from the microphone 112.

The information sorting unit 120 sorts the information input from the information acquisition unit 110 and external information acquired by the communication unit 160 (described below). The information sorting unit 120 outputs determination information, which is information usable for determining the user's riding state with respect to the moving object, among the information from the information acquisition unit 110 and the external information acquired by the communication unit 160, to the riding state determination unit 130. The information sorting unit 120 also outputs, to the notification content determination unit 140, notification information that is information to be notified to the user and is obtained by excluding the determination information from the information from the information acquisition unit 110 among the information from the information acquisition unit 110 and the external information acquired by the communication unit 160.

The riding state determination unit 130 determines the user's riding state with respect to the moving object.

The riding state determination unit 130 determines the user's riding state with respect to the moving object based on the determination information from the information sorting unit 120. The riding state determination unit 130 outputs the determination result to the notification content determination unit 140. Examples of how to determine the riding state include the determination using an image acquired by the camera 111 of the information acquisition unit 110 and the determination using the moving speed of the moving object measured by the speedometer 113 or the GPS device 114. These determination units can be selectively used or used in combination. Other units for determining the riding state are also applicable.

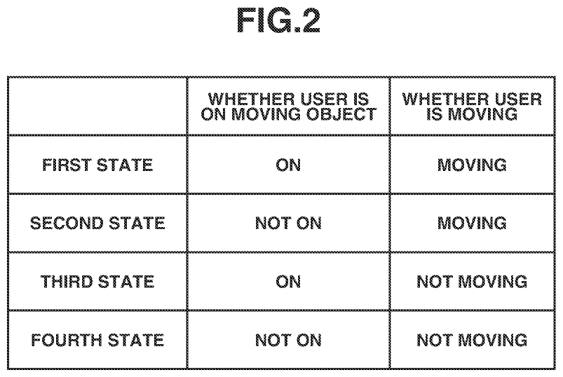

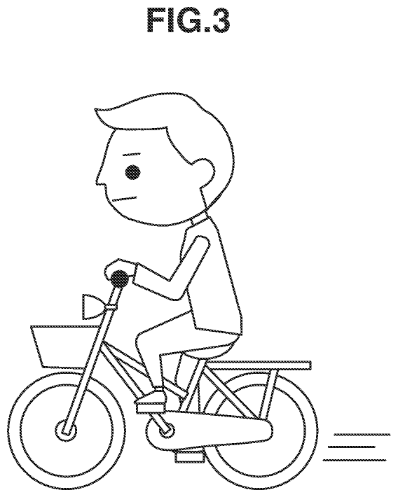

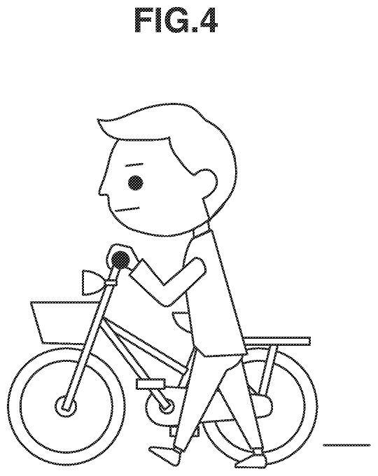

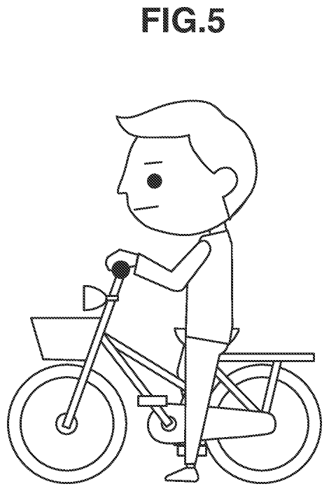

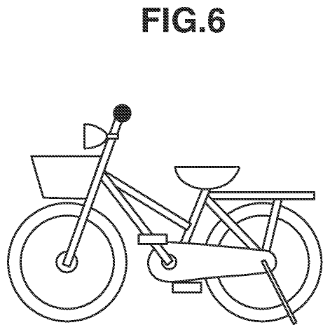

Examples of the riding state determined by the riding state determination unit 130 will be described with reference to FIG. 2. FIG. 2 illustrates examples of the user's riding state to be determined. As illustrated in FIG. 2, the riding state determination unit 130 determines which one of the first to fourth states the user is in based on whether the user is on the moving object and whether the user is moving. The first state refers to a state where the user is riding the moving object, for example, a state where the user is riding a bicycle as illustrated in FIG. 3. The second state refers to a state where the user is moving without getting on the moving object, for example, a state where the user is walking the bicycle as illustrated in FIG. 4. The third state refers to a state where the user is on the moving object at rest, for example, a state where the user is standing on the bicycle with one leg on the ground as illustrated in FIG. 5. The fourth state refers to a state where the moving object is stopped without the user being on the moving object, for example, a state where the user is away from the bicycle as illustrated in FIG. 6.

Returning to FIG. 1, the notification content determination unit 140 analyzes the notification information obtained from the information sorting unit 120, based on the determination result by the riding state determination unit 130 and setting values in the storage unit 180 (described below), and selects notification contents, which are contents to be notified to the user, and an information notification unit (described below). Details of the notification contents, and how to select the notification contents and the information notification unit based on the riding state will be described below. Information about the selected notification contents and information notification unit is output to the information notification unit 150 or the communication unit 160. The information about the selected notification contents and information notification unit and the various pieces of information obtained from the information acquisition unit 110 are output to the storage unit 180 (described below) as appropriate.

The information notification unit 150 includes a group of a plurality of information notification units having different methods for providing the notification contents to the user. The notification contents are provided to the user from one or more of the information notification units. Specific examples of the information notification units include a display 151 for displaying text and video images, a speaker 152 for providing a voice notification by generating a voice, and a vibration device 153 for providing a vibration notification by generating a vibration. Alternatively, the information notification unit 150 can provide the notification contents to the user from an external apparatus (not illustrated) connected to the information processing apparatus 100 via the communication unit 160 (described below).

The communication unit 160 is used to connect to the Internet or an external apparatus (not illustrated). The communication unit 160 acquires external information (described below) by connecting to the Internet or the external apparatus and outputs the information to the information sorting unit 120. The communication unit 160 also transmits the notification contents selected by the notification content determination unit 140 to an external apparatus (not illustrated). The external information refers to general information acquired from a source other than the information acquisition unit 110 of the information processing apparatus 100. Examples of the external information include map information including local or time-specific traffic rules and accident black spot information. Examples of the external information also include weather and disaster information, surrounding information such as a bicycle parking lot, a tourist facility, a station, a public restroom, a convenience store, a bench, and a road closed or under construction, sightseeing information such as a nearby event, and urgent news. Examples of the external apparatus include a display, a speaker, a vibration device, a smartphone, and an infrastructure facility such as a crossing monitoring system.

The setting value input unit 170 is used by the user to input the setting values of the information processing apparatus 100. Examples of the setting values include the brightness of the display 151, the sound volume of the speaker 152, the vibration intensity of the vibration device 153, the on/off state of each notification (described below), position information about the user's home, and position information about a destination. The setting values input to the setting value input unit 170 are output to the storage unit 180 (described below).

The storage unit 180 includes a memory for storing the setting values input to the setting value input unit 170. The stored setting values are referred to by the notification content determination unit 140 to determine the notification contents. The storage unit 180 is also used to store various kinds of information including the various pieces of information acquired by the information acquisition unit 110 and the notification contents determined by the notification content determination unit 140.

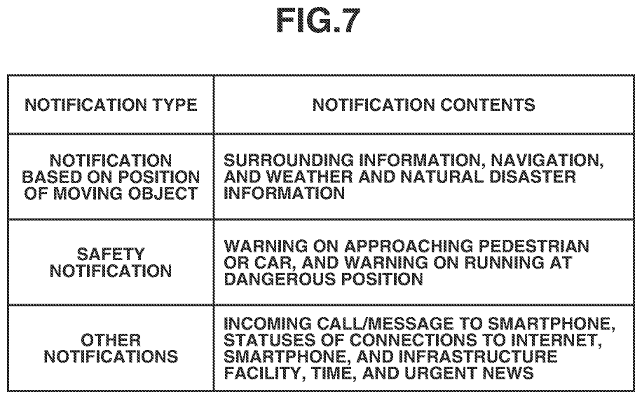

The contents of information to be notified to the user using the moving object by the information processing apparatus 100 will be described with reference to FIG. 7. FIG. 7 illustrates examples of the information to be notified to the user by the information processing apparatus 100. The information processing apparatus 100 notifies various pieces of useful information to the user riding the moving object. In the present example embodiment, the contents of information to be notified are classified into three types: first notification based on the position of the moving object, second notification related to safety, and third notification (any other notification). Each type of notification will now be described.

The first notification based on the position of the moving object will be described first. The first notification is based on the current location detected by the GPS device 114 of the information acquisition unit 110, and the map information and surrounding information acquired from the Internet or the external apparatus connected to the communication unit 160. The information processing apparatus 100 provides the first notification to the user at timing when the user has approached a target object on the map. The target object is a facility related to the information to be notified. Examples of the target object include a bicycle parking lot, a tourist facility, a station, a public restroom, a convenience store, a bench, a road closed or under construction, a nearby event site, a nearby store distributing coupons, a road having local or time-specific traffic rules, and a road at an accident black spot. In addition, based on the destination set in the storage unit 180 by the user, the information processing apparatus 100 provides a navigation notification as guidance on a recommended route at a branch point such as a crossing, and information about weather and natural disasters around the current location and the destination.

The second notification related to safety will be described next. The second notification is to notify the user of a possible dangerous situation based on image data generated by the camera 111 attached to the moving object. For example, the information processing apparatus 100 provides a notification (a warning), for example, in a situation where a pedestrian or a car is approaching the moving object being used by the user and a risk of collision arises, or a situation where the moving object is running near the center of a roadway. In this case, the information processing apparatus 100 determines whether there is a risk of collision through image analysis performed by the notification content determination unit 140 on the image data captured by the camera 111. If the information processing apparatus 100 determines that there is a risk of collision, the information processing apparatus 100 warns the user via each information notification unit of the information notification unit 150. Alternatively, via the communication unit 160 communicating with a monitoring camera installed on the road, the information processing apparatus 100 can determine the risk of collision based on images captured by the monitoring camera. Further alternatively, the information processing apparatus 100 can be configured so that the communication unit 160 of the information processing apparatus 100 directly communicates with a device held by the approaching pedestrian or the approaching car to determine the risk of collision.

Lastly, the third notification (any other notification) will be described. Examples of the third notification include a notification of an incoming call or message to a smartphone connected to the communication unit 160 of the information processing apparatus 100. Since the user basically stores his or her smartphone while moving, the information processing apparatus 100 can make it easier for the user to notice an incoming call or message to the smartphone by providing the third notification. The information processing apparatus 100 also provides notification of statuses of connections to the Internet, the smartphone, and a public infrastructure such as a crossing monitoring system, which are external information acquisition sources, to the user currently moving with the moving object. This produces an effect of grasping whether the user is moving while appropriately acquiring external information. Examples of the third notification also include time information and urgent news acquired from the Internet.

The above-described notifications may have different levels of importance depending on the user's situation and the timing. Thus, the user can cause, via the setting value input unit 170, the storage unit 180 to store the on/off settings indicating the frequency of each notification and whether to provide each notification. The notification content determination unit 140 can refer to the on/off settings when determining the notification contents, and reflect the on/off settings in the notification contents. In particular, it is desirable to automatically enable the setting not to provide surrounding information while the user is near the user's home. More specifically, if the current location detected by the GPS device 114 is, for example, within a 1 km range of the position of the user's home set in the storage unit 180, the information processing apparatus 100 disables the first notification that is based on the position of the moving object. This enables reducing the provision of unnecessary information, thereby making the user less annoyed since it is assumed that the user well knows position information about the nearest facilities around the user's home.

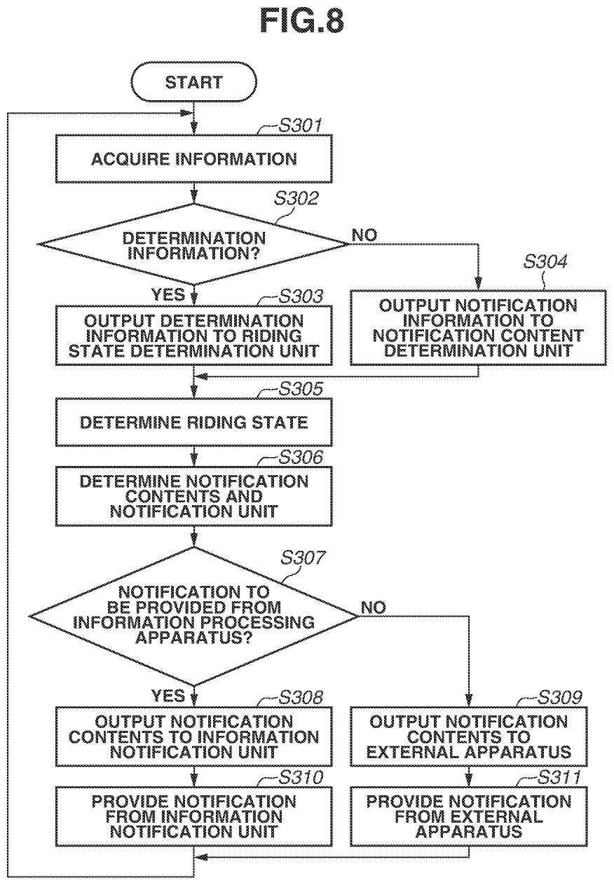

An operation of the information processing apparatus 100 will be described with reference to FIG. 8. FIG. 8 is a flowchart illustrating the operation of the information processing apparatus 100. The flowchart in FIG. 8 is started, for example, when a power switch (not illustrated) of the information processing apparatus 100 is operated. The following processing is implemented by a control unit, such as a central processing unit (CPU) (not illustrated), of the information processing apparatus 100 controlling the units of the information processing apparatus 100. For example, the following processing is implemented when software recorded in the memory of the information processing apparatus 100 is loaded and then executed by the control unit.

In step S301, the information processing apparatus 100 acquires various pieces of information via the information acquisition unit 110 and acquires external information via the communication unit 160. The information processing apparatus 100 outputs the acquired information to the information sorting unit 120.

In step S302, the information sorting unit 120 of the information processing apparatus 100 sorts the various pieces of information and the external information into the determination information and the notification information. In step S303, the information sorting unit 120 outputs the determination information to the riding state determination unit 130. In step S304, the information sorting unit 120 outputs the notification information to the notification content determination unit 140.

In step 305, the information processing apparatus 100 determines the above-described user's riding state with respect to the moving object via the riding state determination unit 130 based on the determination information selected by the information sorting unit 120. In the present example embodiment, the user's riding state with respect to the moving object is classified into four different states (the first to fourth states). These states will be described in detail below.

In step S306, the information processing apparatus 100 determines the notification contents and the information notification unit based on the determination result by the riding state determination unit 130, and the on/off settings of the notifications prestored in the storage unit 180 described above with reference to FIG. 7. The notification content determination unit 140 selects the notification contents from among the notification information from the information sorting unit 120. The notification contents to be determined for each riding state will be described below.

In step S307, the information processing apparatus 100 branches the processing based on the information notification unit determined in step S306. More specifically, if one of the units in the information notification unit 150 of the information processing apparatus 100 is determined as the information notification unit (YES in step S307), the processing proceeds to step S308. In step S308, the information processing apparatus 100 outputs information about the notification contents and the information notification unit determined by the notification content determination unit 140 to the information notification unit 150. In step S310, the information processing apparatus 100 provides the notification contents to the user using the moving object, via the information notification unit 150.

If the communication unit 160 is selected as the information notification unit (NO in step S307), the processing proceeds to step S309. In step S309, the information processing apparatus 100 outputs the notification contents to the communication unit 160. The communication unit 160 then outputs the notification contents to an external apparatus (not illustrated). In step S311, the information processing apparatus 100 provides the notification contents from the external apparatus (not illustrated).

Then, the information processing apparatus 100 repeats the processing of step S301 and the subsequent steps. When the power switch (not illustrated) is operated during steps S301 to S311, the information processing apparatus 100 enters a non-operating state and ends the operation.

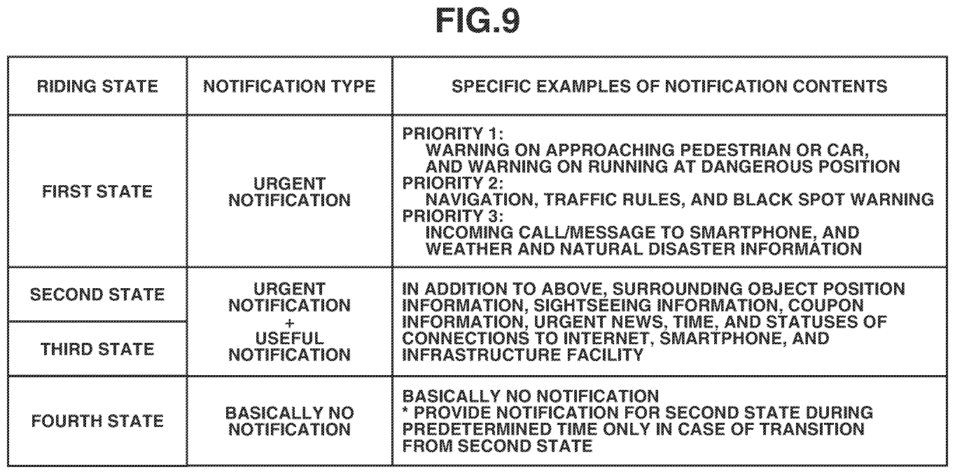

The notification contents determined for each riding state by the notification content determination unit 140 of the information processing apparatus 100 will be described with reference to FIG. 9. FIG. 9 illustrates the notification contents selected for each user's riding state by the notification content determination unit 140 illustrated in FIG. 1.

The notification contents in the first state where the user is riding the moving object as illustrated in FIG. 3 will be described. In the first state, the moving object is moving mainly on a roadway at high speed. In the first state, lots of information is unable to be notified to the user because of a time restriction that the user does not stay in the same location for a long time.

In this case, the information processing apparatus 100 outputs only urgent information/notification to the information notification unit 150. In the present example embodiment, upon receiving information indicating the first state from the riding state determination unit 130, the notification content determination unit 140 further sorts the notification information received from the information sorting unit 120 to reduce the amount of information to be notified compared with those in the other states. These pieces of information are provided by the information notification unit 150. Examples of the provided information include a warning on an approaching pedestrian or car, a warning on a running position on a roadway, a navigation notification of a recommended route, a notification of local traffic rules, an accident black spot warning, a notification of an incoming call or message to the smartphone, and a notification of weather and natural disaster information.

This enables conveying sufficient information to ensure the safe movement of the user riding the moving object, and also enables providing information in a manner to minimize the reduction in the concentration of the traveling user.

The notification content determination unit 140 can prioritize the above-described notifications. More specifically, a warning on an approaching pedestrian or car and a warning on a running position on a roadway are set to Priority 1. A navigation notification of a recommended route, a notification of local traffic rules, and an accident black spot warning are set to Priority 2. A notification of an incoming call or message to the smartphone, and a weather notification are set to Priority 3. For example, if the moving object approaches a pedestrian during the navigation to a recommended route, the information processing apparatus 100 provides a warning on the approaching pedestrian in an interrupt manner.

This enables providing appropriate information to the user riding the moving object at appropriate timing, thus achieving a more comfortable ride. In the first state, the user is riding the moving object and concentrates on driving the moving object. Thus, it is not desirable, for example, to display information on the display 151 because this disturbs the user's concentration. In the first state, the notification content determination unit 140 thus notifies information by voice using the speaker 152 as the information notification unit.

The notification contents in the second state where the user is walking the moving object as illustrated in FIG. 4 will be described. In the second state, the moving object moves mainly on a sidewalk at low speed. In the second state, since the moving speed is lower than in the first state, the user stays in the same location for a comparatively long time, and thus the user has more time to spare.

Thus, the notification content determination unit 140 outputs more pieces of information than that in the first state to the information notification unit 150. In the present example embodiment, upon receiving information indicating the second state from the riding state determination unit 130, the notification content determination unit 140 receives the notification information from the information sorting unit 120, and outputs useful information together with urgent information to the information notification unit 150.

Examples of the useful information include position information about objects such as a nearby bicycle parking lot, a tourist facility, a station, a public restroom, a convenience store, and a bench, and sightseeing information such as a nearby event. Examples of the useful information also include coupon information about a nearby store, urgent news, time information, and statuses of connections to the Internet, the smartphone, and an infrastructure facility. Notifying a combination of these pieces of information to the user can achieve a more comfortable ride.

As for the navigation to a recommended route, the route most convenient for the user may differ depending on road attributes such as the presence of a bicycle lane and the width of the sidewalk. In such a case, the information processing apparatus 100 can notify information about the most convenient route for the current riding state as the recommended route. As described above, in the second state, the user has more time to spare and thus attentive information can be notified to the user using the moving object. Thus, in the second state, the notification content determination unit 140 selects the display 151 and the speaker 152 as the information notification units and provides the information using both display and voice notifications.

The notification contents in the third state where the user is on the moving object at rest as illustrated in FIG. 5 will be described. Examples of the third state include a situation immediately before the user starts riding the moving object, and a situation where the user is stopping to wait at a stoplight or watch the smartphone. In the case of the moving object such as a bicycle or a motorcycle, the user is sitting on the moving object with one leg on the ground. In the third state, while the user is on the moving object, the user has time to spare and is less likely to cause a traffic accident.

As illustrated in FIG. 9, in the third state, the information processing apparatus 100 provides the notification contents as in the second state. However, many pieces of information may be provided to the user only when the current location of the moving object is on a sidewalk. This enables preventing the user from being distracted by the provided information and continuously stopping at a position such as the center of a roadway.

The notification contents in the fourth state where the moving object is stopped without the user being on the moving object will be described. The fourth state is a state where the user completes the traveling, stops the moving object, and moves away from the moving object as illustrated in FIG. 6, or a state where the user walking the moving object is temporarily stopping in the second state. Basically, in the fourth state, the information processing apparatus 100 does not notify information to the user since the user is assumed to be away from the moving object for a prolonged period of time. However, only in the case of a transition to the fourth state from the second state where the user is walking the moving object or from the third state where the user is on the moving object at rest, the information processing apparatus 100 may continue to notify information for a predetermined period of time. This enables notifying information during the time when the user stops walking the moving object in the second state or during the time before the user moves far away from the moving object, and also enables avoiding notification of useless information to any user other than the owner.

The above-described information notification enables the information processing apparatus 100 to notify information based on the time that the user using the moving object can afford in each riding state, thus achieving a comfortable ride. In other words, the information processing apparatus 100 can notify information based on the state of the user using the moving object.

The information processing apparatus 100 according to the present example embodiment is merely an example of an information notification device, and an information notification system is not limited thereto. For example, an information notification system can include an information processing apparatus 200 and an external apparatus 290 according to a second example embodiment (described below).

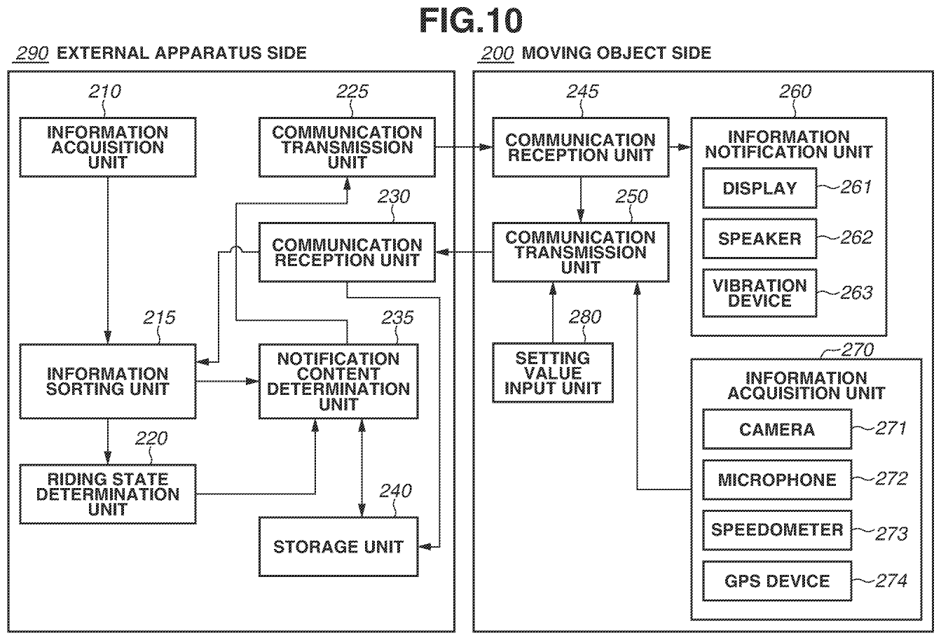

FIG. 10 is a block diagram illustrating example configurations of the information processing apparatus 200 and the external apparatus 290 according to the present example embodiment. The information processing apparatus 200 is an information notification device for notifying various pieces of useful information to the user riding the moving object such as a bicycle or a motorcycle.

When attached to the moving object, the information processing apparatus 200 enables notifying various pieces of information, such as safety information for safe traveling and surrounding information related to nearby stores, to the user using the moving object. When connected to the information processing apparatus 200, the external apparatus 290 assists the information processing apparatus 200 in notifying the information. For example, the external apparatus 290 is disposed in an infrastructure facility such as a crossing monitoring system. As illustrated in FIG. 10, the information processing apparatus 200 disposed on the moving object includes a communication reception unit 245, a communication transmission unit 250, an information notification unit 260, an information acquisition unit 270, and a setting value input unit 280. The external apparatus 290 disposed outside the moving object includes an information acquisition unit 210, an information sorting unit 215, a riding state determination unit 220, a communication transmission unit 225, a communication reception unit 230, a notification content determination unit 235, and a storage unit 240.

The information acquisition unit 270 on the moving object includes a group of units for acquiring information that can be acquired by the moving object. More specifically, the information acquisition unit 270 includes a camera 271 for capturing images of the front, sides, and back of the moving object, a microphone 272 for collecting environmental sounds and user's voice, a speedometer 273 for measuring the moving speed of the moving object, and a GPS device 274 for acquiring information about the current location of the moving object. The various pieces of information acquired by the information acquisition unit 270 on the moving object are output to the communication transmission unit 250 (described below) on the moving object.

The communication reception unit 245 on the moving object receives information about the contents to be notified to the user and the information notification unit selected by the notification content determination unit 235 (described below) of the external apparatus 290, via the communication transmission unit 225 (described below) of the external apparatus 290, and outputs the information to the information notification unit 260 (described below).

The communication transmission unit 250 on the moving object outputs the various pieces of information acquired by the information acquisition unit 270 and the setting values input to the setting value input unit 280 (described below) to the communication reception unit 230 (described below) of the external apparatus 290.

The information notification unit 260 on the moving object includes a group of units for notifying various pieces of information. The information notification unit 260 receives the notification contents selected by the notification content determination unit 235 (described below) via the communication reception unit 245 on the moving object, and provides the notification contents to the user.

Specific examples of the information notification units include a display 261 for performing a display, a speaker 262 for providing a voice notification, and a vibration device 263 for generating a vibration. Alternatively, these notification units can be implemented by an external apparatus (not illustrated) attached to the moving object and connected to the information processing apparatus 200 via the communication transmission unit 250.

The setting value input unit 280 on the moving object is used to input the setting values of the information processing apparatus 200. Examples of the setting values include the brightness of the display 261, the sound volume of the speaker 262, the vibration intensity of the vibration device 263, the on/off state of each notification, position information about the user's home, and position information about the destination. The setting values input to the setting value input unit 280 are output to the communication transmission unit 250 on the moving object.

The information acquisition unit 210 of the external apparatus 290 includes a group of units for acquiring various pieces of information that can be acquired by the external apparatus 290. For example, the information acquisition unit 210 includes a camera and a microphone for a crossing monitoring system, connects to the Internet, and acquires external information. The external information to be acquired is similar to that in the first example embodiment, and detailed descriptions thereof will be omitted. The various pieces of information acquired by the information acquisition unit 210 of the external apparatus 290 are output to the information sorting unit 215 (described below).

The communication reception unit 230 of the external apparatus 290 receives the various pieces of information acquired by the information acquisition unit 270 on the moving object and the setting values input to the setting value input unit 280 on the moving object, via the communication transmission unit 250 on the moving object, and outputs the information and the setting values to the information sorting unit 215 (described below).

The communication transmission unit 225 of the external apparatus 290 outputs the notification contents and notification unit selected by the notification content determination unit 235 (described below) to the communication reception unit 245 on the moving object.

The information sorting unit 215 of the external apparatus 290 sorts the various pieces of information and the external information output from the information acquisition unit 210 and the communication reception unit 230. The information sorting unit 215 outputs the determination information usable for determining the user's riding state with respect to the moving object, among the various pieces of information and the external information, to the riding state determination unit 220 (described below). The information sorting unit 215 selects, from among the above-described various pieces of information and external information, the notification information that is the information to be notified to the user and is obtained by excluding the determination information from the various pieces of information, and outputs the notification information to the notification content determination unit 235 (described below).

The riding state determination unit 220 of the external apparatus 290 automatically determines the user's riding state with respect to the moving object, based on the determination information from the information sorting unit 215, and outputs the determination result to the notification content determination unit 235. The method for determining the riding state is similar to that according to the first example embodiment.

The notification content determination unit 235 of the external apparatus 290 analyzes the information obtained from the information sorting unit 215 based on the determination result by the riding state determination unit 220 and the setting values in the storage unit 240 (described below), and selects the notification contents to be provided to the user and the information notification unit. Details of the notification contents, and how to select the notification contents and the information notification unit based on the riding state are similar to those according to the first example embodiment. Information about the selected notification contents and information notification unit is output to the communication transmission unit 225 of the external apparatus 290. In addition, the information about the selected notification contents and information notification unit, and the various pieces of information and the external information obtained from the information acquisition units 210 and 270 are output to the storage unit 240 (described below) as appropriate.

The storage unit 240 of the external apparatus 290 is used to store the setting values input to the setting value input unit 280 on the moving object. The notification content determination unit 235 refers to the stored setting values to determine the notification contents and the information notification unit. The storage unit 240 is also used to store various kinds of information including the various pieces of information acquired by the information acquisition unit 210 and the notification contents determined by the notification content determination unit 235.

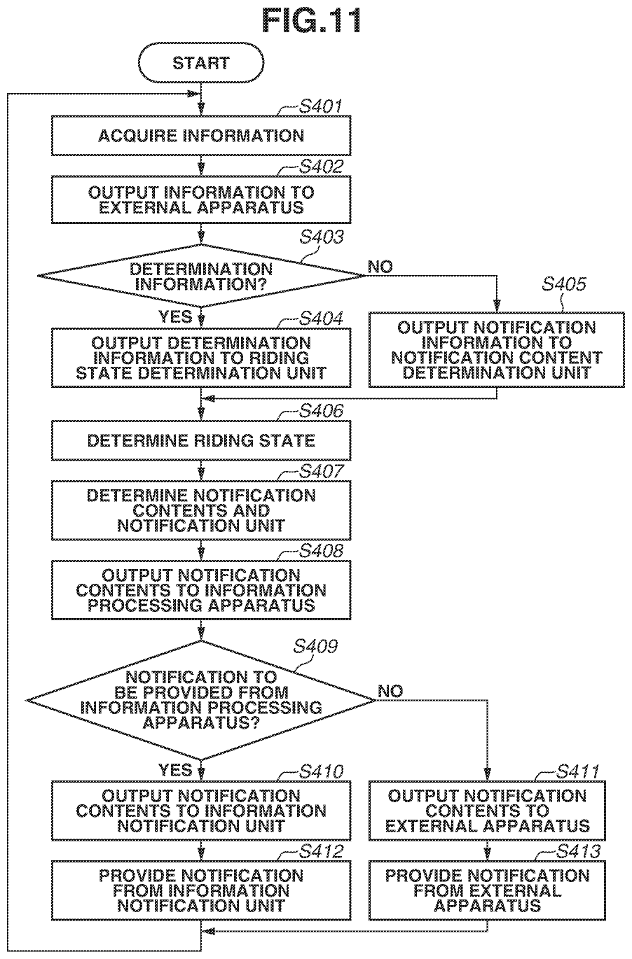

Operations of the information processing apparatus 200 and the external apparatus 290 will be described with reference to FIGS. 10 and 11. FIG. 11 is a flowchart illustrating the operations of the information processing apparatus 200 and the external apparatus 290. The flowchart in FIG. 11 is started, for example, when a power switch (not illustrated) of the information processing apparatus 200 is operated.

In step S401, the information acquisition unit 270 of the information processing apparatus 200 and the information acquisition unit 210 of the external apparatus 290 acquire various pieces of information and external information. The various pieces of information acquired by the information acquisition unit 270 on the moving object are output to the communication transmission unit 250 on the moving object, and the external information acquired by the information acquisition unit 210 of the external apparatus 290 is output to the information sorting unit 215.

In step S402, the information processing apparatus 200 outputs the information acquired by the information acquisition unit 270 on the moving object, from the communication transmission unit 250 on the moving object to the communication reception unit 230 of the external apparatus 290.

In step S403, the information sorting unit 215 of the external apparatus 290 sorts the various pieces of information and the external information acquired from the information acquisition unit 210 and the communication reception unit 230 into the determination information and the notification information. In step S404, the information sorting unit 215 outputs the determination information to the riding state determination unit 220. In step S405, the information sorting unit 215 outputs the notification information to the notification content determination unit 235.

In step 406, the riding state determination unit 220 determines the above-described user's riding state with respect to the moving object, based on the determination information selected by the information sorting unit 215. Similarly to the first example embodiment, the user's riding state with respect to the moving object is classified into four states, i.e., the first to the fourth states in the present example embodiment.

In step S407, the notification content determination unit 235 sorts the notification information from the information sorting unit 215 based on the determination result by the riding state determination unit 220 and the setting values for each notification prestored in the storage unit 240, and determines the notification contents and the information notification unit. Notifications to be provided in each riding state are similar to those according to the first example embodiment.

In step S408, the communication transmission unit 225 of the external apparatus 290 outputs information about the notification contents and the information notification unit determined by the notification content determination unit 235, to the communication reception unit 245 on the moving object.

In step S409, the processing branches based on the information notification unit determined in step S407. If one of the units in the information notification unit 260 of the information processing apparatus 200 is determined as the information notification unit (YES in step S409), the processing proceeds to step S410. In step S410, the communication reception unit 245 outputs the information about the notification contents and the information notification unit determined by the notification content determination unit 235 to the information notification unit 260. In step S412, the information processing apparatus 200 provides the notification contents to the user using the moving object, via the information notification unit 260.

If the communication transmission unit 250 is selected as the information notification unit (NO in step S409), the processing proceeds to step S411. In step S411, the communication reception unit 245 outputs the notification contents to the communication transmission unit 250. Then, the communication transmission unit 250 outputs the notification contents to an external apparatus (not illustrated). In step S413, the information processing apparatus 200 provides the notification contents to the user using the moving object, from the external apparatus (not illustrated).

Then, the external apparatus 290 repeats the processing of step S401 and the subsequent steps. When the power switch (not illustrated) is operated during steps S401 to S413, the information processing apparatus 200 enters the nonoperating state and ends the operation.

The determination of the riding state by the information processing apparatus 200 and the notification contents for each riding state are similar to those according to the first example embodiment, and redundant descriptions thereof will be omitted.

As described above, according to the present example embodiment, the information processing apparatus 200 to be disposed on the moving object can be configured with less components than the information processing apparatus 100 according to the first example embodiment. This achieves the information processing apparatus 200 having a smaller size.

While the example embodiments of the present disclosure have been described above, embodiments of the present disclosure are not limited thereto but can be modified and changed in diverse ways within the scope of the appended claims.

For example, the functions of the information processing apparatus 100 or 200 can be implemented by a smartphone.

It is also possible to determine the riding state based not on the information acquired by the information acquisition unit 110 or 270 attached to the moving object but on the information from a camera attached to a public infrastructure facility such as a crossing monitoring system, acquired via the communication unit 160 or the information acquisition unit 210. This enables acquiring external information based on the user's riding state, thus producing an effect of reducing the processing load of the notification content determination unit 140 or 235, compared with the configuration for determining the notification contents after gathering all pieces of information.

### OTHER EMBODIMENTS

Various embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present disclosure has been described with reference to example embodiments, it is to be understood that the disclosure is not limited to the disclosed example embodiments. The scope of the following claims is to be accorded the broadest interpretation so as to encompass all such modifications and equivalent structures and functions.

This application claims the benefit of Japanese Patent Application No. 2022-086421, filed May 26, 2022, which is hereby incorporated by reference herein in its entirety.

What is claimed is:

1. An information processing apparatus comprising:
one or more memories storing instructions; and
one or more processors executing the instructions to:
acquire surrounding information or external information about a moving object;
determine a riding state of a user with respect to the moving object based on the acquired information;
determine, based on the user's riding state with respect to the moving object, information to be notified to the user from among the acquired information; and
notify the determined information to the user.

2. The information processing apparatus according to claim 1, wherein the one or more processors further execute the instructions to:
determine the user's riding state with respect to the moving object as a first riding state where the user is riding the moving object or a second riding state where the user is walking the moving object.

3. The information processing apparatus according to claim 2, wherein an amount of information to be notified in the second riding state is larger than an amount of information to be notified in the first riding state.

4. The information processing apparatus according to claim 2, wherein, in the first riding state, contents to be notified to the user are prioritized and, among the contents, a higher-priority content is notified earlier than a lower-priority content.

5. The information processing apparatus according to claim 4, wherein, in prioritizing the contents, a notification related to the user's safety is assigned highest priority.

6. The information processing apparatus according to claim 2, wherein the one or more processors further execute the instructions to:
determine the user's riding state with respect to the moving object as a third riding state where the user is on the moving object at rest, other than the first riding state and the second riding state.

7. The information processing apparatus according to claim 6, wherein an amount of information to be notified in the third riding state is larger than an amount of information to be notified in the first riding state.

8. The information processing apparatus according to claim 6,
wherein the one or more processors further execute the instructions to:
detect a current location of the moving object,
wherein, in a case where the user's riding state with respect to the moving object is determined as the third riding state and the detected current location of the moving object is not on a sidewalk, the one or more processors provide a notification similar to a notification in the first riding state.

9. The information processing apparatus according to claim 6, wherein the one or more processors further execute the instructions to:
determine the user's riding state with respect to the moving object as a fourth riding state where the moving object is stopped without the user being on the moving object, other than the first riding state, the second riding state, and the third riding state.

10. The information processing apparatus according to claim 9, wherein, in a case where the user's riding state with respect to the moving object is determined as the fourth riding state, the one or more processors do not notify information to the user.

11. The information processing apparatus according to claim 9, wherein, in a case where the user's riding state with respect to the moving object is determined as the fourth riding state and a transition to the fourth riding state has been made from the second riding state or the third riding state, the one or more processors notify information to the user for a predetermined period of time after the transition.

12. The information processing apparatus according to claim 1,
wherein the one or more processors further execute the instructions to:
detect a current location of the moving object; and
set a position of the user's home,
wherein, in a case where the current location of the moving object is detected as being near the set position of the user's home in notifying information via an information notification unit, the one or more processors do not notify the surrounding information.

13. A control method for an information processing apparatus, the control method comprising:
acquiring surrounding information or external information about a moving object;
determining a riding state of a user with respect to the moving object based on the acquired information;
determining, based on the user's riding state with respect to the moving object, information to be notified to the user from among the acquired information; and
notifying the determined information to the user.

14. A non-transitory computer-readable storage medium storing a program for causing a computer to perform a control method for an information processing apparatus, the control method comprising:
acquiring surrounding information or external information about a moving object;
determining a riding state of a user with respect to the moving object based on the acquired information;
determining, based on the user's riding state with respect to the moving object, information to be notified to the user from among the acquired information; and
notifying the determined information to the user.
